(19) United States
(12) Patent Application Publication
(10) Pub. No.: US 2025/0372338 A1
(43) Pub. Date: Dec. 4, 2025

(54) X-RAY SYSTEM WITH ELECTRICALLY INSULATIVE SOURCE TARGET MATERIAL

(71) Applicant: Sigray, Inc., Benicia, CA (US)

(72) Inventors: Wenbing Yun, Walnut Creek, CA (US); Benjamin Donald Stripe, Walnut Creek, CA (US); Frances Yenan Su, Walnut Creek, CA (US); Vikaram Singh, Concord, CA (US); Sylvia Jia Yun Lewis, San Francisco, CA (US); Janos Kirz, Berkeley, CA (US)

(21) Appl. No.: 19/236,777

(22) Filed: Jun. 12, 2025

Related U.S. Application Data
(63) Continuation of application No. 18/175,171, filed on Feb. 27, 2023, now Pat. No. 12,360,067.
(60) Provisional application No. 63/268,778, filed on Mar. 2, 2022.

(51) Int. Cl. H01J 35/14; H01J 35/16

(52) U.S. Cl. CPC H01J 35/147; H01J 35/16; H01J 2235/081; H01J 2235/088

(57) ABSTRACT

A system includes a stage for supporting a sample having at least first and second atomic elements. The first atomic element has a first characteristic x-ray line with a first energy and the second atomic element has a second characteristic x-ray line with a second energy, the first and second energies lower than 8 keV and separated from one another by less than 1 keV. The system further includes an x-ray source of x-rays having a third energy between the first and second energies and at least one x-ray optic configured to receive and focus at least some of the x-rays as an x-ray beam to illuminate the sample.

### CLAIM OF PRIORITY

This application is a continuation from U.S. application Ser. No. 18/175,171, filed Feb. 27, 2023, which claims the benefit of priority to U.S. Provisional Appl. No. 63/268,778 filed on Mar. 2, 2022 and incorporated in its entirety by reference herein.

### STATEMENT REGARDING FEDERALLY SPONSORED R&D

This invention was made with Government support under Contract Nos. NIH R43GM112287 and NIH R44GM112413, awarded by the National Institute of Health. The Government has certain rights in the invention.

### BACKGROUND

### Field

This application relates generally to x-ray systems.

### Description of the Related Art

X-ray fluorescence (XRF) analysis of materials comprising multiple elements can experience problems due to spectral interference, where the difference in energy between characteristic x-ray fluorescence lines of different elements is less than or compatible with the resolution of the spectrometer used. Spectral interference is particularly problematic when an energy dispersive x-ray detector is used for lower energy x-ray fluorescence lines (e.g., <5 keV) because most elements in the periodic table have characteristic x-ray lines of energies less than 5 keV, including K x-ray lines of lower Z elements, and L and M x-ray lines of higher Z elements. In addition, the energy resolution of the energy dispersive detector, such as a silicon drift detector, typically ranges from about 50 eV to about 120 eV in the low x-ray energy range. This problem is exacerbated when quantifying an element of low concentration having spectral interference with an element of high concentration in the same sample.

### SUMMARY

Certain implementations described herein provide a system comprising a stage configured to support a sample comprising at least first and second atomic elements. The first atomic element has a first characteristic x-ray line with a first energy and the second atomic element has a second characteristic x-ray line with a second energy, the second energy greater than the first energy. The first energy and the second energy are lower than 8 keV and are separated from one another by less than 1 keV. The system further comprises an x-ray source comprising at least one target material configured to produce x-rays having a third energy between the first and second energies. The system further comprises at least one x-ray optic configured to receive and focus at least some of the x-rays from the x-ray source as an x-ray beam to illuminate the sample. At least 70% of the x-ray beam has x-ray energies that are below the second energy. The system further comprises at least one x-ray detector configured to detect fluorescence x-rays produced by the sample in response to being irradiated by the x-ray beam.

Certain implementations described herein provide an x-ray source comprising an electrically insulating target material having a thickness less than 10 microns. The target material is configured to emit x-rays upon being impinged by electrons accelerated by an accelerating voltage in a range of 5 kVp to 30 kVp. The x-ray source further comprises a diamond substrate material in thermal communication with the target material. The diamond substrate material is configured to transfer heat away from the target material, the heat generated by the target material being impinged by the electrons.

### BRIEF DESCRIPTION OF THE DRAWINGS

FIGS. 1A and 1B schematically illustrate two examples of an x-ray fluorescence measurement system in accordance with certain implementations described herein.

FIGS. 2A and 2B are flow diagrams of two examples of a method for analyzing a sample in accordance with certain implementations described herein.

FIG. 3 shows two XRF spectra from about zero to about 20 keV of a silicon (Si) sample irradiated by two different excitation x-ray beams.

FIG. 4 shows three XRF spectra from about zero to about 20 keV of a silver (Ag) sample irradiated by three different excitation x-ray beams.

FIG. 5 shows an XRF spectrum from about 0.5 keV to about 6.5 keV acquired from a sample comprising SnAg solder microbumps in accordance with certain implementations described herein.

FIG. 6 shows an expanded view of the spectral region from about 2 keV to about 4.7 keV of the XRF spectra acquired from samples comprising SnAg solder microbumps with standardized Ag concentrations in accordance with certain implementations described herein.

### DETAILED DESCRIPTION

One example of XRF analysis that can experience issues due to spectral interference is the accurate measurement of Ag concentration in lead-free solder bumps in electronic packages that comprises tin (Sn) and silver (Ag), an important metrology/inspection analysis in manufacturing electronic packages using SnAg-based solder bumps. It can be difficult to use an EDS (energy dispersive spectrometer), such as silicon drift detector (SDD), to accurately quantify the concentration of Ag in SnAg solder bumps (e.g., microbumps). First, the concentration of Ag (e.g., in a range of 1% to 3%) is typically much smaller than the concentration of Sn (e.g., in a range greater than 97%). Second, the energy difference between the Sn Lγ x-ray line (e.g., 3.045 keV) and either of the Ag Lα, Lβ x-ray lines (e.g., energies of 2.984 keV and 3.15 keV, respectively) is less than the energy resolution of conventional EDS detectors, and thus there is strong spectral overlap.

Though a wavelength dispersive spectrometer (WDS) can have sufficient energy resolution to reduce the spectral overlap, WDS typically collects fluorescence x-rays with significantly smaller collection solid angles than does EDS, typically ranging from 10X to 500X smaller. Quantification of Ag concentration utilizes a sufficiently large number of Ag characteristic x-ray lines to meet Poisson statistic constraints, and WDS is typically much slower in data acquisition than EDS and can be too slow to meet the desired throughput for accurate measurement of Ag concentration in SnAg microbumps. Additionally, XRF measurement of Ag content in SnAg solder bumps in air with EDS can suffer problems due to the spectral overlap of Ag L x-ray lines and argon (Ar) K x-ray lines (e.g., energy of 3.19 keV) from Ar present in the air. Although data analysis with peak fitting of the overlapping spectral x-ray lines can be used to mitigate some of the spectral overlap problems in Ag concentration measurement, spectral overlap still creates uncertainty in accurate XRF measurement of Ag concentration.

In some applications (e.g., metrology of Ag concentration in SnAg microbumps in semiconductor packages), small spot analysis (e.g., x-ray spot widths in a range of 2 microns to 20 microns) is used. Such small spot sizes can further impose difficulty in accurate XRF measurements of Ag concentration due to small analysis volume and small focus spot sizes with small x-ray flux. Compared with SEM-EDS, which can achieve high spatial resolution, XRF offers an advantage with higher signal to background ratio and also can operate in ambient pressure.

Because of these problems, current spectroscopy (e.g., XRF and SEM-EDS) methods struggle to adequately measure the Ag content in solders.

Although the fluorescence yield of the Sn Lγ x-ray line is about 23X less than that of the Ag Lα x-ray line, the high concentration ratio of Sn/Ag in SnAg solder bumps (e.g., a concentration ratio of about 50X) can lead to Sn Lγ x-ray line intensities higher than that of the Ag Lα x-ray line in x-ray spectra generated by conventional x-ray excitation beams. Certain implementations described herein provide an x-ray excitation beam configured to illuminate (e.g., irradiate) SnAg solder structures of a sample and generate the Ag Lα and Lβ x-ray lines with intensities that are at least comparable with or larger than the intensity of the Sn Lγ x-ray line.

Certain implementations described herein provide microanalytical x-ray applications at these lower energy x-ray lines utilizing x-ray optics with a solid angle of collection that increases as the inverse square of the x-ray energy. For example, the x-ray source can comprise a W-containing target which is impinged by an electrons having an acceleration voltage in a range of 8 kVp to 20 kVp, and the x-ray optic can comprise a capillary focusing (e.g., ellipsoid) x-ray optic with sufficient demagnification to get a sufficiently small spot size and a fluorescence x-ray detector optimized to collect fluorescence x-rays having energies in a range of 3.5 keV to 4 keV. In certain implementations, the x-ray optic contains an internal multilayer coating that substantially monochromatizes the polychromatic x-rays produced by the W-containing target of the x-ray source. In certain other implementations, the internal surface of the x-ray optic is uncoated or is coated with a material having a high atomic number, such as platinum.

Certain implementations described herein generate a focused x-ray excitation beam (e.g., having a spot size in a range of 1 micron to 25 microns) for analyzing small SnAg solder structures (e.g., bumps; microbumps), To avoid spectral interference of Ar with Ag L x-ray lines, the amount of Ar atoms in the excitation x-ray beam path can be reduced (e.g., by performing the XRF measurements in vacuum or by flushing N₂ or He along and/or in the excitation x-ray beam path near the analysis area, for example, in front of the x-ray detector).

To achieve an Ag Lα x-ray line intensity that is at least comparable with or larger than the Sn Lγ x-ray line intensity, certain implementations described herein comprise an x-ray source and an x-ray optic configured to produce an x-ray excitation beam having a spectrum with a high percentage of x-rays of energies between the Ag L absorption edge (e.g., at about 3.35 keV) and the Sn L absorption edge (e.g., at about 3.93 keV). For small spot analysis, certain implementations utilize an x-ray focusing optic configured to focus x-rays to a spot size in a range of 1 micron to 25 microns. An energy resolving detector system, such as a silicon drift detector, can be used as the fluorescence x-ray detector.

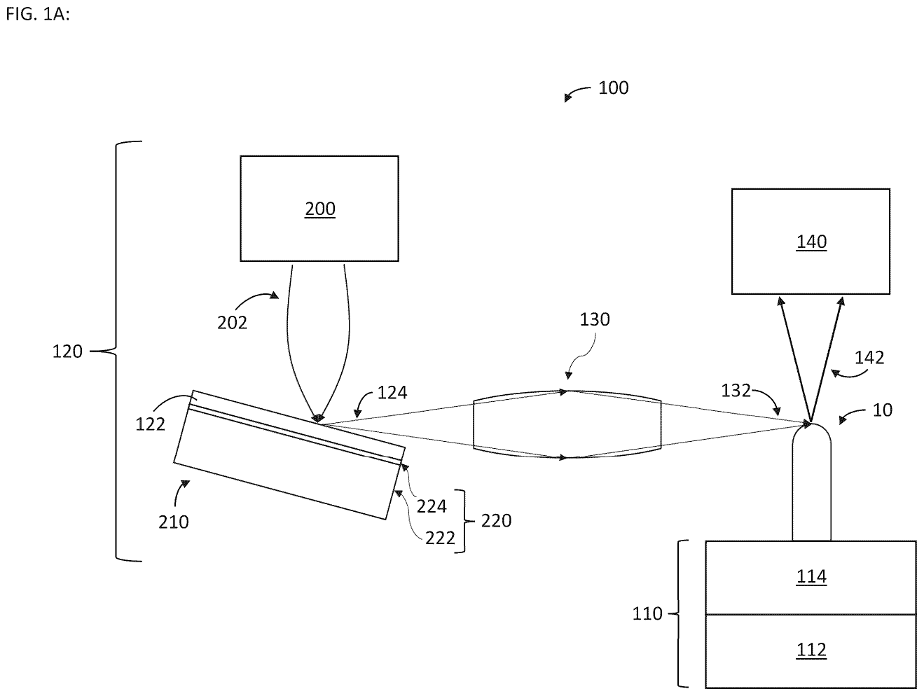

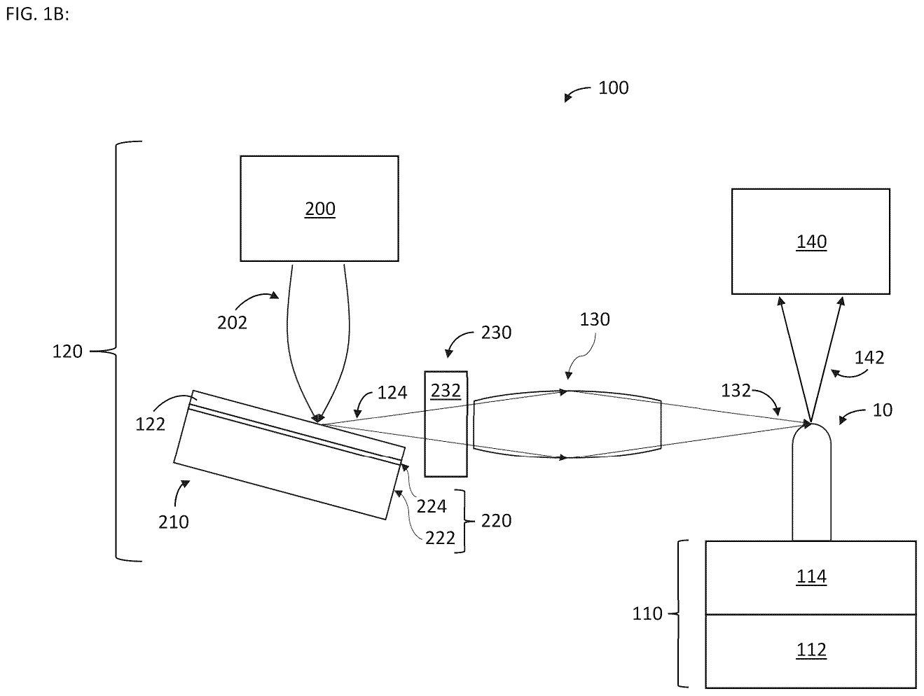

FIGS. 1A and 1B schematically illustrate two examples of an x-ray fluorescence measurement system 100 in accordance with certain implementations described herein. The system 100 is configured to analyze a sample 10 comprising at least first and second atomic elements. The first atomic element has a first characteristic x-ray line with a first energy, the second atomic element has a second characteristic x-ray line with a second energy, and the second energy greater than the first energy. The first energy and the second energy can be in a range lower than 8 keV (e.g., lower than 6 keV; lower than 5 keV) and are separated from one another by less than 1 keV. The system 100 comprises a stage 110 configured to support the sample 10 comprising the at least first and second atomic elements. The system 100 further comprises an x-ray source 120 comprising at least one target material 122 configured to produce x-rays 124 with a third energy between the first and second energies. The system 100 further comprises at least one x-ray optic 130. In certain implementations, the x-ray optic has a cut-off energy that is 50% to 100% of an absorption edge energy associated with the second characteristic x-ray line. The at least one x-ray optic 130 is configured to receive at least some of the x-rays 124 from the x-ray source 120 and to direct (e.g., focus) at least some of the received x-rays 124 as an x-ray beam 132 (e.g., an x-ray excitation beam) onto the sample 10. For example, at least 70% of the x-rays of the excitation beam can have x-ray energies that are below the second energy. The system 100 further comprises at least one x-ray detector 140 configured to detect fluorescence x-rays 142 produced by the sample 10 in response to being illuminated (e.g., irradiated) by the x-ray beam 132.

### Sample Stage

In certain implementations, the stage 110 comprises at least one substage 112 that is motorized and computer-controlled (e.g., comprising an electromechanical system; goniometer; electromechanical motion driver; rotary motor; stepper motor; motor with encoder; linear motion driver with worm drive). The at least one substage 112 can be configured to linearly translate the sample 10 along one, two, or three directions (e.g., x-, y-, and z-direction substages 112 that can move the sample 10 along substantially perpendicular directions, one of which is substantially perpendicular to a surface of the sample 10). The at least one substage 112 can be further configured to rotate the sample 10 about at least one rotation axis. For example, the rotation axis can be substantially perpendicular to a surface of the sample 10 such that rotation of the sample 10 modifies the azimuthal angle along which the x-ray beam 132 propagates to illuminate (e.g., irradiate) the sample 10. For another example, the rotation axis can be substantially parallel to a surface of the sample 10 such that rotation of the sample modifies the tilt angle between the surface of the sample 10 and the propagation direction of the x-ray beam 132. In certain implementations, the at least one substage comprises at least one goiniometer.

In certain implementations, the stage 110 further comprises a sample mount 114 on the at least one substage 112, the sample mount 114 configured to hold the sample 10. For example, the sample mount 114 can be configured to hold a sample 10 comprising a substantially planar integrated circuit wafer such that a normal direction to the wafer is substantially parallel to a linear translation direction and/or a rotation axis of the at least one substage 112.

### X-ray Source

In certain implementations, the x-ray source 120 comprises at least one electron beam source 200 configured to generate an electron beam 202 and at least one x-ray target 210 (e.g., anode) configured to be impinged by the electron beam 202 and comprising the at least one target material 122. The at least one target material 122 is configured to generate the x-rays 124 in response to the electron beam 202. The at least one electron beam source 200 can comprise an electron source (e.g., dispenser cathode; lanthanum hexaboride; tungsten pin; not shown) and electron optics (e.g., three grid stacks; electromagnetic optics; not shown) configured to focus the at least one electron beam 202 onto the at least one x-ray target 210. The spot size of the electron beam 202 at the at least one target material 122 (e.g., the lateral width along a surface of the x-ray target 210) and/or the spot size of the x-ray generating region of the at least one target material 122 (e.g., the lateral width along a surface of the target material 122) can be in a range of less than or equal to 100 microns (e.g., less than or equal to 1 micron; 1 micron to 5 microns; 5 microns to 20 microns; 20 microns to 100 microns). The at least one electron beam source 200 can be operated in the range of 5 kVp to 30 kVp (e.g., 10 kVp to 15 kVp; 15 kVp to 20 kVp; 20 kVp to 30 kVp). The x-ray source 120 can be a reflection-type x-ray source having a power in a range of 10 W to 2 kW (e.g., 10 W to 30 W; 30 W to 50 W; 50 W to 100 W; 100 W to 2 kW). In certain implementations in which the x-ray source 120 comprises a reflection x-ray source, the at least one target material 122 is under vacuum and the x-ray source 120 does not have a window, while in certain other such implementations, the x-ray source 120 comprises an exit window (e.g., comprising beryllium or silicon nitride; 25 microns to 500 microns in thickness; not shown) through which the generated x-rays 124 propagate.

In certain implementations, the at least one target material 122 is has low electrical conductivity or is electrically insulative (e.g., ceramic; glass). For example, the at least one target material 122 can comprise at least one calcium-containing material, examples of which include but are not limited to: Ca, CaB₆, CaO, calcium carbide, calcium fluoride (CaF), or other compounds of calcium or ceramic formulations of calcium. Ceramics are generally not used as x-ray target materials because they are insulators and can charge up under electron bombardment. Furthermore, ceramics are alloys of materials, which have lower percentages of the atomic clement generating the x-rays of interest as compared to the pure material, so the characteristic x-ray lines are weaker from alloys as compared to the pure material. For these reasons, most x-ray target materials are electrically conductive pure metals, such as Rh, Au, Pd, W, etc. With a thin layer of low electrical conductivity ceramic materials (e.g., thickness less than 5 microns or less than 1 micron), energetic electrons used for generating x-rays can tunnel through and thus these ceramic materials can be used for the target material, provided an electrically conductive path is provided.

The x-rays 124 generated by the Ca-containing material in response to an electron beam 202 in a range of 5 kVp to 30 kVp include Ca K x-ray line x-rays as a large fraction of the x-ray spectrum on top of continuum (e.g., Bremsstrahlung) radiation. The energy of the Ca Kα x-ray lines are above the Ag L absorption edges and are below the Sn L absorption edges, so these x-rays 124 are efficient in generating Ag L-line fluorescence x-rays from SnAg solder structures of the sample 10 while not generating Sn L-line fluorescence x-rays. The x-rays 124 with energies greater than the Sn L absorption edge can be used to generate Sn L fluorescence x-rays and Ag fluorescence x-rays. To achieve measurement of the Sn/Ag ratio, these higher energy x-rays can be only a fraction of the amount of Ca Kα x-ray lines reaching the sample. Because the Ca Kβ x-ray line is strong, a filter can be used to substantially reduce the Ca Kβ x-ray line. The relatively weak continuum x-rays 124 from the Ca target can be used for Sn excitation.

In certain other implementations, the at least one target material 122 comprises at least one material containing a material having a high atomic number (e.g., Z greater than 42), examples of which include but are not limited to: tungsten (W), rhodium (Rh), and molybdenum (Mo). The x-rays 124 can be generated by the target material in response to an electron beam 202 in a range of 6 kVp to 20 kVp (e.g., about 10 kVp). In certain such implementations, as schematically illustrated by FIG. 1B, the system 100 further comprises at least one filter 230 comprising at least one filter material 232 positioned in the path of the x-rays 124 propagating from the x-ray source 120 to the at least one x-ray optic 130 and/or in the path of the x-ray beam 132 propagating from the at least one x-ray optic 130 to the sample 10. The x-rays impinging the at least one filter 230 are spectrally filtered by transmission through the at least one filter material 232 (e.g., a first portion of the x-rays transmitted through the at least one filter material 232 and a second portion of the x-rays absorbed by the at least one filter material 232). The at least one filter material 232 has a thickness (e.g., in a range of 1 micron to 10 microns; about 5 microns) configured to allow the first portion of the impinging x-rays to propagate through the at least one filter material 222 while absorbing the second portion of the impinging x-rays. For example, the at least one filter material 232 can have a high x-ray transmission for x-rays with energies between the L absorption edges of Ag and Sn and a low x-ray transmission for x-rays with energies above the L absorption edge of Sn. Examples of such filter materials 232 include but are not limited to Sn-containing materials (e.g., SnO). Filtering by the at least one filter material 232 can lead to an increased strength (e.g., intensity) of Ag L x-ray lines relative to Sn L x-ray lines in the fluorescence x-rays 142 generated by SnAg solder structures of the sample 10 and received by the at least one detector 140. While FIG. 1B shows the at least one filter 230 between the x-ray source 120 and the x-ray optic 130, the at least one filter 230 can be a component of the x-ray source 120 (e.g., at least a portion of an exit window of the x-ray source 120) and/or of the at least one x-ray optic 130.

In certain implementations, the at least one target 210 comprises a thermally conductive and electrically conductive substrate 220 comprising at least one substrate material 222 (e.g., diamond; copper) and the at least one target material 122 comprises at least one layer on and in thermal communication with the substrate 220. For example, an electrically insulative target material 122 can be in thermal contact with the at least one substrate material 222 having a high thermal conductivity (e.g., sufficiently high to transfer heat away from the target material 122 to substantially reduce or avoid thermal damage to the target material 122). The at least one substrate material 222 of certain implementations comprises a low atomic number material, examples of which include but are not limited to: diamond which comprises carbon; beryllium; sapphire which comprises aluminum and oxygen. Other examples of the at least one substrate material 222 include but are not limited to copper.

In certain implementations in which the at least one target material 122 is electrically insulative (e.g., ceramic; glass), the at least one target material 122 is directly adhered to the substrate material 222. For example, the at least one electrically insulative target material 122 can comprise a thin layer (e.g., having a thickness in a range of 1 micron to 10 microns) in direct contact with the diamond substrate material 222. In certain other implementations in which the at least one electrically insulative target material 122 is on a diamond substrate material 222, the x-ray target 210 further comprises at least one intermediate layer 224 between the at least one target material 122 and the diamond substrate material 222 (e.g., providing adhesion between the at least one target material 122 and the diamond substrate material 222 and/or providing protection against diffusion of the at least one target material 122 into the diamond substrate material 222). For example, the at least one electrically insulative target material 122 can have a thickness in a range of 1 micron to 10 microns (e.g., 1 micron to 3 microns; 3 microns to 5 microns; 5 microns to 10 microns), and the at least one intermediate layer 224 can have a thickness in the range of 1 nanometer to 100 nanometers (e.g., 1 nanometer to 30 nanometers; 30 nanometers to 100 nanometers). In certain implementations, the at least one intermediate layer 224 comprises at least one atomic element that has good wetting properties to the at least one electrically insulative target material 122 and to the diamond substrate material 222 (e.g., titanium (Ti)).

In certain implementations, the at least one electrically insulative target material 122 is configured to not substantially charge up upon being impinged by the electron beam 202 of the x-ray source 120. For example, the at least one electrically insulative target material 122 can have a thickness less than or equal to 10 microns such that substantial charge leakage from the top of the at least one electrically insulative target material 122 to the underlying electrically conductive diamond substrate material 222 can occur. For another example, the at least one electrically insulative target material 122 can have a thickness greater than 10 microns and can be positioned within trenches (e.g., 3 microns wide) on the top surface of the diamond substrate material 222. The top of the at least one electrically insulative target material 122 can be sufficiently close to the surrounding top surface of the diamond substrate material 222 such that substantial charge leakage from the at least one electrically insulative target material 122 to the neighboring electrically conductive diamond substrate material 222 can occur.

In certain implementations, the at least one target 210 further comprises a coating (e.g., top layer; sealant layer; not shown) over the at least one target material 122, the coating comprising a different, low atomic number material (e.g., carbon; boron carbide) than the at least one target material 122. In certain implementations, the at least one target material 122 is deposited onto the underlying structure (e.g., the substrate material 222; the intermediate layer 224) by sputtering or any other thin film deposition approaches known to those versed in the art.

In certain implementations, the at least one target material 122 comprises at least one atomic element having at least one third characteristic x-ray line with an energy between the first and second energies of the first and second atomic elements of the sample 10. The x-rays 124 generated by the at least one target material 122 and received by the at least one x-ray optic 130 can comprise x-rays of the at least one third characteristic x-ray line.

In certain implementations, the takeoff angle for the x-rays 124 generated by the at least one target material 122 of the x-ray source 120 and received by the x-ray optic 130 can be in the range of: 1 degree to 30 degrees (e.g., 1 degree to 6 degrees; 6 degrees to 15 degrees; 15 degrees to 30 degrees). For example, the take-off angle for the at least one target material 122 can be higher than that for target materials comprising pure metals (e.g., greater than 6 degrees). For low characteristic energies of interest, self-attenuation can reduce the amount of generated x-rays 124 that propagate from the x-ray source 120 to the x-ray optic 130.

### X-ray Optic

In certain implementations, the at least one x-ray optic 130 is configured to focus at least some of the x-rays 124 generated by the x-ray source 120 at the sample 10 (e.g., within the sample 10; on a surface of the sample 10). The optical surface profile of the at least one x-ray optic 130 can be quadric. Examples of such focusing x-ray optics 130 include but are not limited to: pairs of (e.g., double) paraboloidal capillary optics; ellipsoidal demagnifying capillary optics; polycapillary optics. For example, the at least one x-ray optic 130 can comprise a capillary with a glass substrate and can be coated with a high atomic number material (e.g., platinum).

Demagnifying optics can be used for XRF analysis of solder bumps (e.g., microbumps) with sizes in a range of 15 microns to 30 microns (e.g., 20 microns to 25 microns). With an x-ray source 120 having a spot size of 12 microns to 20 microns, a demagnifying x-ray optic 130 can focus the x-ray beam 132 at the sample 10 to have a spot size in the range of 3 microns to 12 microns while maintaining high x-ray flux. In certain implementations, the demagnifying x-ray optic 130 is configured to demagnify by a ratio in a range of 2:1 to 10:1 (e.g., 4:1, 6:1, 7:1).

In certain implementations, the at least one x-ray optic 130 has a curvature such that x-rays 124 received by the x-ray optic 130 having energies below a predetermined cut-off energy undergo total external reflection and are directed (e.g., reflected) to propagate towards the sample 10 as the x-ray beam 132, while x-rays 124 with energies above the predetermined cut-off energy are not directed to propagate towards the sample 10. The critical angle of external reflection can be approximated as:

$${θ}_{C} = \frac{30}{E} * \frac{\sqrt{Z}}{\sqrt{{Z}_{S i}}} ,$$

where E is the x-ray energy in keV, Z is the atomic number of the surface coating (e.g., Pt, Ir, Rh, Au, etc.) of the x-ray optic 130, and Z_{Si} is the atomic number of silicon and is equal to 14. The cut-off energy can also be measured as the x-ray energy below which x-rays that are incident upon the surface of the x-ray optic 130 have a reflectivity that is approximately equal to one. In certain other implementations, the reflectivity for x-rays having energies below the cut-off energy is above a predetermined threshold (e.g., above 90%, in a range of 80% to 90%, in a range of 50% to 80%).

The predetermined cut-off energy can be lower than the absorption edge energy associated with the second characteristic x-ray line (e.g., the characteristic x-ray line of the first and second atomic elements of the sample 10 with the higher energy). In certain implementations, the cut-off energy decreases both the background contribution of the XRF spectra received by the at least one x-ray detector 140 and the probability that the second atomic element (e.g., the atomic element with the higher characteristic x-ray line energy) is excited by the x-ray beam 132. Decreasing the background in the XRF spectra can result in a higher signal-to-noise ratio, which can be helpful for quantifying trace elements.

### X-ray Detector

In certain implementations, the at least one x-ray detector 140 comprises an energy dispersive detector (e.g., having an optimal energy resolution less than 180 eV), while in certain other implementations, the at least one x-ray detector 140 comprises a wavelength dispersive spectrometer (e.g., comprising a crystal monochromator and an x-ray detecting element; having an energy resolution lower than 5 eV). In certain implementations, the energy dispersive detector comprises a silicon drift detector (SDD). In certain implementations in which the at least one x-ray detector 140 comprises an energy dispersive detector, XRF signals (e.g., counts) from multiple atomic elements can be acquired concurrently. In certain implementations, the at least one x-ray detector 140 can comprise a first wavelength dispersive detector for detecting XRF signals from the first atomic element (e.g., the first characteristic x-ray line) and a second wavelength dispersive detector for detecting XRF signals from the second atomic element (e.g., the second characteristic x-ray line). Certain such implementations can improve the detection of the minor atomic element (e.g., the atomic element of the first and second atomic elements with the lesser concentration within the sample 10). In certain other implementations, a single wavelength dispersive detector can be used by switching between detection angles (e.g., angles relative to the sample 10 over which XRF signals are detected) to acquire XRF signals from both the first and second characteristic x-ray lines from the first and second atomic elements.

### Example Method

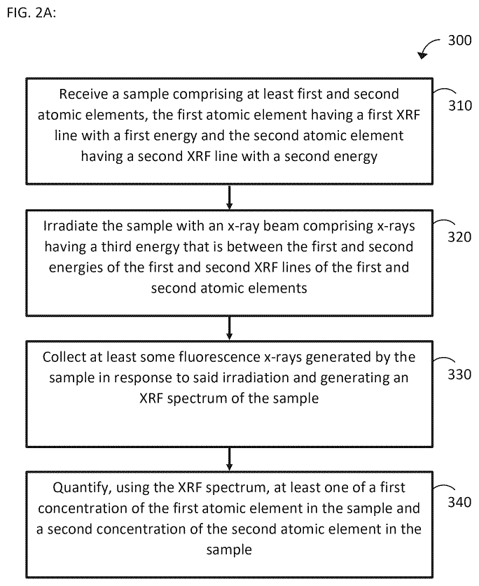

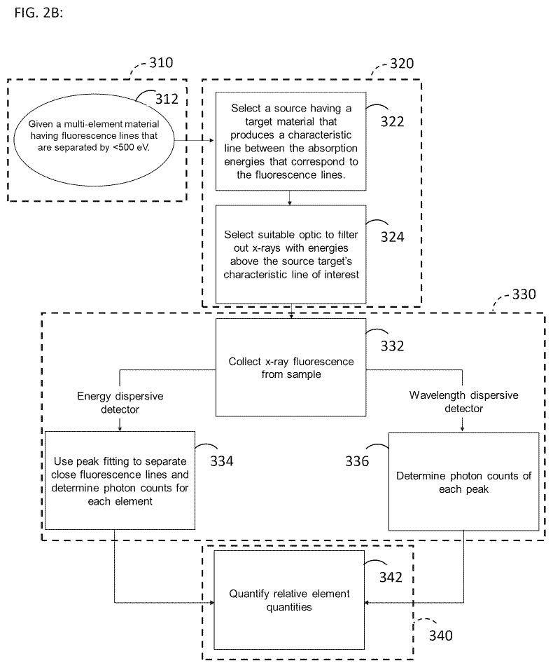

FIGS. 2A and 2B are flow diagrams of two examples of a method 300 for analyzing a sample in accordance with certain implementations described herein. While the examples of the method 300 is described herein by referring to the example system 100 of FIGS. 1A-1B, other systems and apparatuses are also compatible with the examples of the method 300 in accordance with certain implementations described herein.

In an operational block 310, the method 300 comprises receiving a sample 10 comprising at least first and second atomic elements (e.g., co-located within 50 microns of one another within the sample 10). The first atomic element has a first characteristic XRF line with a first energy and the second atomic element has a second characteristic XRF line with a second energy. In certain implementations, at least one of the first and second characteristic XRF lines is an L-line or an M-line. The second energy is greater than the first energy by an energy difference. For example, the first energy and the second energy can be in a range of less than or equal to 5 keV (e.g., less than or equal to 4 keV) and/or the energy difference can be in an energy range of less than or equal to 1000 eV (e.g., less than or equal to 100 eV; less than or equal to 200 eV; less than or equal to 500 eV). For example, as shown in FIG. 2B, said receiving can comprise an operational block 312 comprising being given a multi-element material (e.g., a wafer comprising SnAg solder bumps) having XRF lines that are separated by less than 500 eV. The first characteristic XRF line corresponds to a first absorption edge and the second characteristic XRF line corresponds to a second absorption edge. In certain implementations, the first and second atomic elements, the first and second characteristic XRF lines, and the first and second absorption edges are predetermined prior to performing the method 300. In certain implementations, one of the first and second atomic elements comprises at least 90% of the composition of the sample by weight. In certain implementations, a ratio of one of the first and second atomic elements to the other of the first and second atomic elements is in a range of greater than or equal to 5:1.

In an operational block 320, the method 300 further comprises irradiating the sample 10 with an x-ray beam 132 comprising x-rays having a third energy that is between the first and second energies of the first and second characteristic XRF lines (e.g., more than 40% of the x-ray beam 132 consisting of x-rays having the third energy). For example, said irradiating can comprise using at least one x-ray optic 130 to receive x-rays 124 comprising the x-rays having the third energy, to focus or collimate at least some of the received x-rays 124 into the x-ray beam 132, and to direct the x-ray beam 132 towards the sample 10. The at least one x-ray optic 130 can have a cut-off energy that is less than an energy of the second absorption edge.

For example, as shown in FIG. 2B, said irradiating can comprise an operational block 322 comprising selecting an x-ray source 120 having at least one target material 122 configured to generate the x-rays 124 having the third energy in response to electron bombardment of the at least one target material 122. For example, the third energy can be a characteristic line of the at least one target material 122. Said irradiating can further comprise an operational block 324 comprising selecting the at least one x-ray optic 130 to filter out x-rays with energies above the third energy (e.g., x-rays of the characteristic x-ray line of the target material 122).

In an operational block 330, the method 300 further comprises collecting at least some fluorescence x-rays generated by the sample 10 in response to said irradiating and generating an XRF spectrum of the sample 10 in response to said collecting. For example, as shown in FIG. 2B, said collecting comprises an operational block 332 comprising collecting at least some fluorescence x-rays 142 from the sample 10 (e.g., using at least one x-ray detector 140). If an energy dispersive detector is used to collect the fluorescence x-rays 142, said collecting can further comprise an operational block 334 which comprises performing peak fitting to the XRF spectrum. The peak fitting can comprise separating close XRF lines of the XRF spectrum and determining photon counts for each of the first and second atomic elements. If a wavelength dispersive detector is used to collect the fluorescence x-rays 142, said collecting can further comprise an operational block 336 which comprises determining photon counts of each peak of the XRF spectrum.

In an operational block 340, the method 300 further comprises quantifying, using the XRF spectrum, at least one of a first concentration of the first atomic element in the sample 10 and a second concentration of the second atomic element in the sample 10. For example, as shown in FIG. 2B, said quantifying can comprise quantifying relative quantities of the first and/or second atomic elements.

### Example Implementation: Ca-Containing Target Material

In certain implementations, the x-ray source 120 comprises a target material 122 comprising at least one Ca-containing material (e.g., CaB₆, pure Ca, CaO) in thermal contact with a diamond substrate material 222. The at least one Ca-containing material is configured to produce Ca Kα line x-rays 124 with an energy of 3.69 keV, which is between the Sn absorption edge and most of the Ag L absorption edges. CaB₆ has a high melting point (e.g., about 2235° C.).

In certain implementations in which small spot analysis or high resolution mapping of Ag concentration in SnAg solder bumps is to be performed, the at least one x-ray optic 130 comprises an x-ray focusing optic 130 with a wide spectral band and configured to receive the x-rays 124 emitted from the x-ray source 120 and to focus at least some of the x-rays 124 as an x-ray beam 132 onto the sample 10. For example, the x-ray focusing optic 130 can comprise a capillary mirror lens with a quadric (e.g., ellipsoidal) inner surface profile. The x-ray focusing optic 130 can provide a high percentage of Ca K line x-rays for efficient production of Ag L x-ray lines from the sample 10 while providing Sn L x-ray lines with Bremsstrahlung radiation of energies above the Sn L absorption edge. The x-ray reflections from the capillary mirror lens and/or the electron acceleration voltage impacting on the at least one target 210 can be configured to optimize the fluorescence x-ray spectra from the sample 10 so that the Ag Lα and Sn Lα x-ray lines have comparable (e.g., substantially equal) intensities but with substantially larger intensities than does the Sn Lγ x-ray line. For a target material 122 comprising an electrically insulative Ca-containing material (e.g., having a low electrical conductivity), an electrically conductive path can be provided from the target material 122 to the underlying substrate 220 and from the substrate 220 to ground to avoid charging of the target 210.

Once the XRF spectrum is collected, the data can be processed through a peak fitting algorithm which can take into account the relative peak intensities of the other L x-ray lines with respect to the Ag Lα x-ray line. The peak fitting algorithm can also be applied to the K x-ray lines if these x-ray lines are acquired. Relative weight or atomic percentages of elements can then be calculated (e.g., using a fundamental parameters model based on the x-ray source, x-ray optics, and geometries of various components).

### Example Implementation: Barium Titanium Analyzer

For certain samples 10 (e.g., multilayer ceramic capacitors), XRF from barium (Ba) and titanium (Ti) can be of interest. Ba has an Lα x-ray line with an energy of 4.466 keV and Ti has a Kα x-ray line with an energy of 4.512 keV. In certain implementations, the Ba L1, L2, and L3 absorption edges are at 5.989 keV, 5.624 keV, and 5.247 keV, respectively, and the Ti K absorption edge is at 4.966 keV. In certain implementations, an x-ray target material 122 can be used to generate x-rays 124 with a characteristic x-ray line energy between the Ti K-edge and one or more of the Ba L edges. For example, an x-ray source target material 122 comprising Cr can be used to produce x-rays 124 with characteristic Kα x-ray energy of 5.4149 keV.

In certain such implementations, a dual energy approach can be used. For example, a first x-ray source target material 122 comprising Cr with a first characteristic x-ray energy (e.g., 5.4149 keV) can be used in conjunction with a first x-ray optic 130 with a first cut-off energy (e.g., 5.5 keV) to excite Ba L3 and Ti K x-ray lines. A second x-ray source target material 122 (e.g., comprising Cu) with a second characteristic x-ray energy (e.g., 8.04 keV) can then be used in conjunction with a second x-ray optic 130 having a second cut-off energy that excites all Ba and Ti x-ray lines. By peak fitting to the higher (e.g., non-excited) Ba absorption edges (e.g., Ba L2 and L3 emission x-ray lines), the intensity of the Ba L3 x-ray line can be determined, and the intensity of the Ti K x-ray line can be determined by subtracting the expected intensity of the Ba L3 x-ray line.

### Example X-ray Spectra

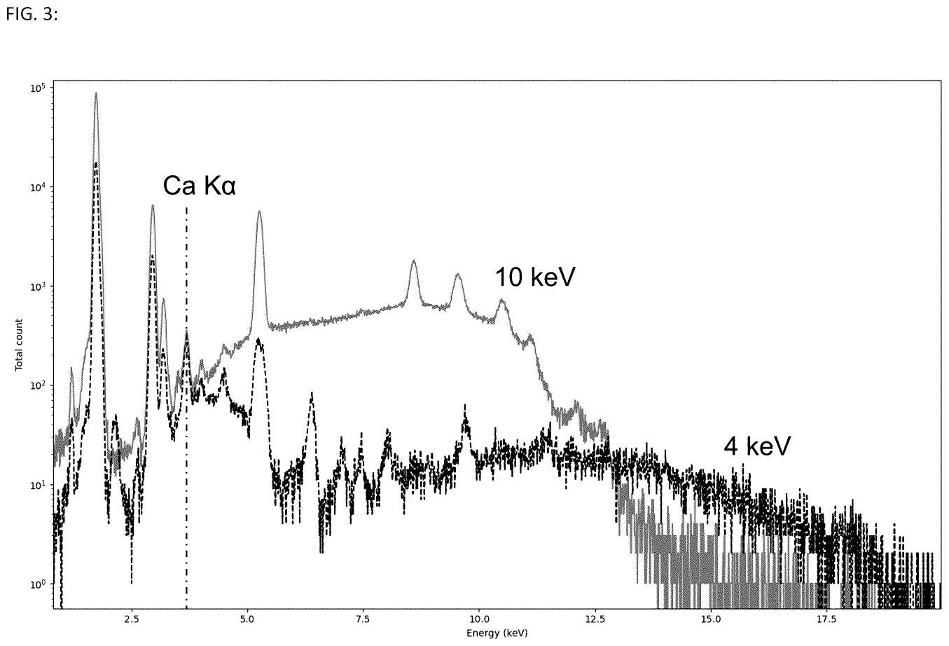

FIG. 3 shows two XRF spectra from about zero to about 20 keV of a silicon (Si) sample 10 irradiated by two different excitation x-ray beams 132. The excitation x-ray beams 132 were generated by an x-ray source 120 having a CaB₆ target material 122 paired with (i) an x-ray optic 130 having a high reflectivity (e.g., greater than 50%; greater than 70%) below 10 keV and (ii) an x-ray optic 130 having a high reflectivity below 4 keV. The x-ray source 120 was operated at 20 kVp with an electron beam current of 1500 microamps. X-rays above 4 keV contribute to higher background in the low energy regime due to incomplete charge collection by the silicon drift detector.

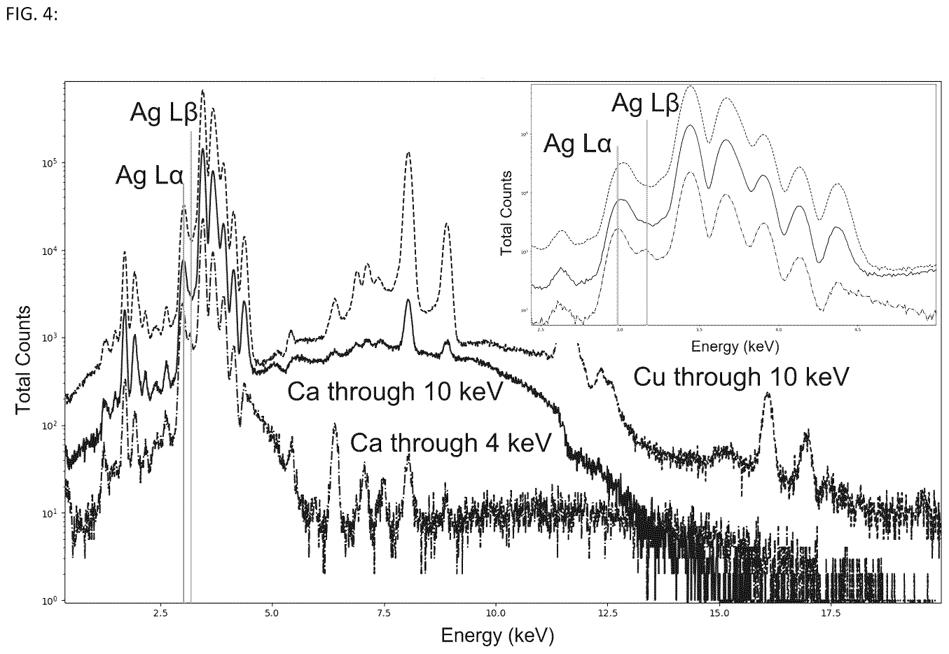

FIG. 4 shows three XRF spectra from about zero to about 20 keV of a silver (Ag) sample 10 irradiated by three different excitation x-ray beams 132. The excitation x-ray beams 132 were generated by an x-ray source 120 having (i) a CaB₆ target material 122 paired with an x-ray optic 130 having a high reflectivity (e.g., greater than 50%; greater than 70%) below 10 keV, (ii) a CaB₆ target material 122 paired with an x-ray optic 130 having a high reflectivity below 4 keV, and (iii) a Cu target material 122 paired with an x-ray optic 130 having a high reflectivity below 10 keV. The inset of FIG. 4 is an expanded view of the spectral region from about 2.5 keV to about 5 keV of the XRF spectra, which includes the Ag Lα and Lβ lines. The insert shows that the Ag Lβ XRF line can most clearly be seen using the CaB₆ target material 122 paired with the x-ray optic 130 having a high reflectivity below 4 keV.

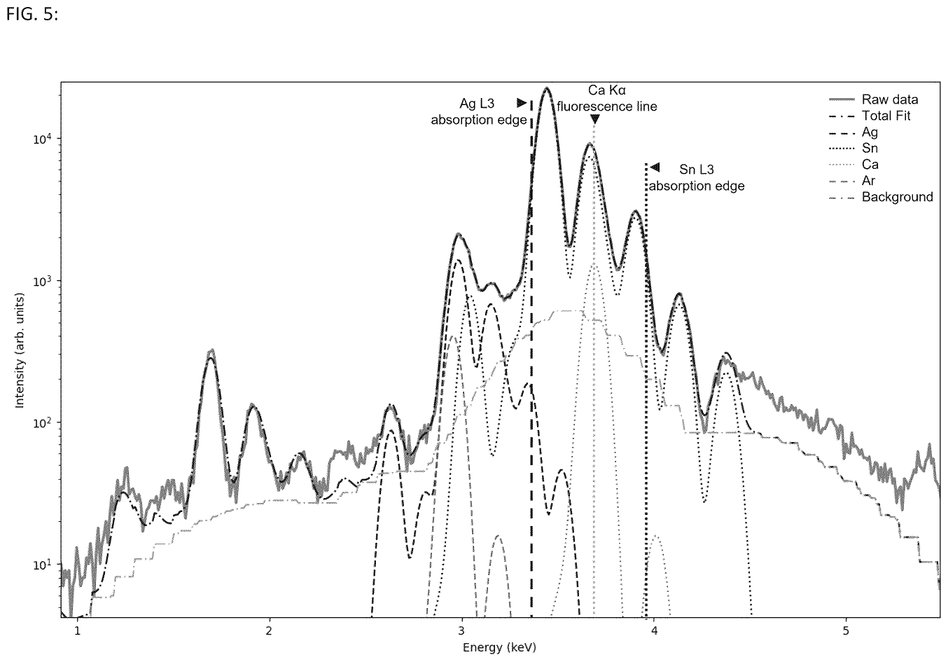

FIG. 5 shows an XRF spectrum from about 0.5 keV to about 6.5 keV acquired from a sample 10 comprising SnAg solder microbumps in accordance with certain implementations described herein. The excitation x-ray beam 132 was generated by a system 100 having a CaB₆ target material 122 and a He flush. The vertical dashed lines denote the Ag L3 absorption edge energy, the fluorescence Ca Kα line energy, and the Sn L3 absorption edge energy. FIG. 5 demonstrates that the fluorescence Ca Kα line energy is between the Ag L3 absorption edge energy and the Sn L3 absorption edge energy and demonstrates clear Ag Lα and Lβ peaks.

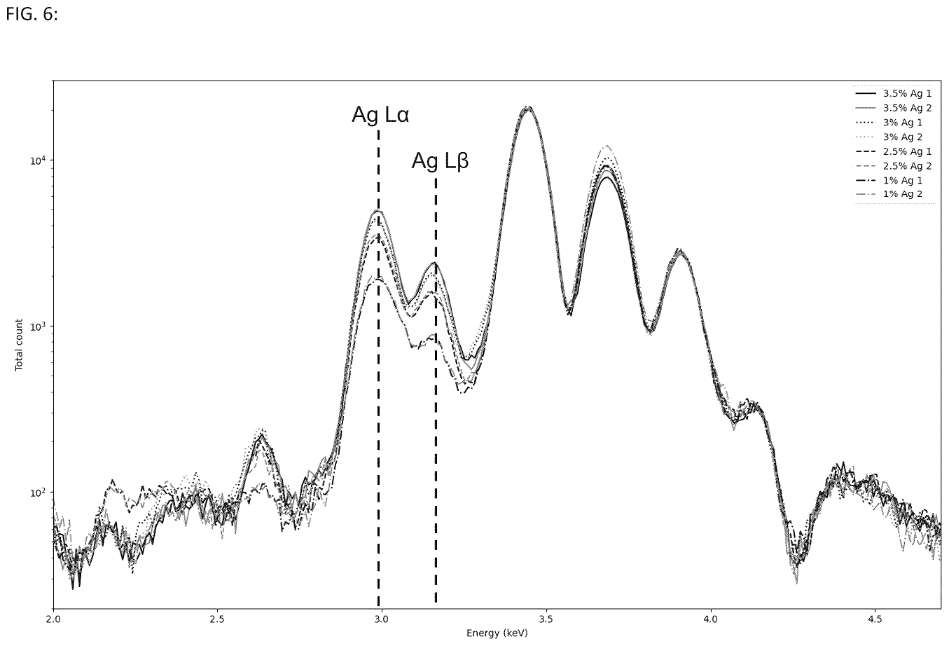

FIG. 6 shows an expanded view of the spectral region from about 2 keV to about 4.7 keV, which includes the Ag Lα and Lβ lines, of the XRF spectra acquired from samples 10 comprising SnAg solder microbumps with standardized Ag concentrations (e.g., standard Ag %) in accordance with certain implementations described herein. The excitation x-ray beam 132 was generated by a system 100 having a CaB₆ target material 122 and an 12 kVp, 10 W electron beam 202. The XRF spectra were acquired with an acquisition time of 300 seconds per point.

Using the XRF spectra of FIG. 6, the Ag concentration percentages were calculated using a fundamental parameters (FP) model. Table 1 shows a comparison of the standardized Ag concentrations of the samples 10 to the FP-estimated Ag % from the XRF spectra of FIG. 6.

TABLE 1

| Standard Ag % | FP-estimated Ag % |
|---|---|
| 1.002 | 0.9719 |
| 1.002 | 0.9386 |
| 2.47 | 2.1374 |
| 2.47 | 2.1061 |
| 3.07 | 2.8889 |
| 3.07 | 2.7833 |
| 3.50 | 3.2249 |
| 3.50 | 3.2927 |

Although commonly used terms are used to describe the systems and methods of certain implementations for ease of understanding, these terms are used herein to have their broadest reasonable interpretations. Although various aspects of the disclosure are described with regard to illustrative examples and implementations, the disclosed examples and implementations should not be construed as limiting. Conditional language, such as “can,” “could,” “might,” or “may,” unless specifically stated otherwise, or otherwise understood within the context as used, is generally intended to convey that certain implementations include, while other implementations do not include, certain features, elements, and/or steps. Thus, such conditional language is not generally intended to imply that features, elements, and/or steps are in any way required for one or more implementations. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

Conjunctive language such as the phrase “at least one of X, Y, and Z,” unless specifically stated otherwise, is to be understood within the context used in general to convey that an item, term, etc. may be either X, Y, or Z. Thus, such conjunctive language is not generally intended to imply that certain implementations require the presence of at least one of X, at least one of Y, and at least one of Z.

Language of degree, as used herein, such as the terms “approximately,” “about,” “generally,” and “substantially,” represent a value, amount, or characteristic close to the stated value, amount, or characteristic that still performs a desired function or achieves a desired result. For example, the terms “approximately,” “about,” “generally,” and “substantially” may refer to an amount that is within ±10% of, within ±5% of, within ±2% of, within ±1% of, or within ±0.1% of the stated amount. As another example, the terms “generally parallel” and “substantially parallel” refer to a value, amount, or characteristic that departs from exactly parallel by ±10 degrees, by ±5 degrees, by ±2 degrees, by ±1 degree, or by ±0.1 degree, and the terms “generally perpendicular” and “substantially perpendicular” refer to a value, amount, or characteristic that departs from exactly perpendicular by ±10 degrees, by ±5 degrees, by ±2 degrees, by ±1 degree, or by ±0.1 degree. The ranges disclosed herein also encompass any and all overlap, sub-ranges, and combinations thereof. Language such as “up to,” “at least,” “greater than,” less than,” “between,” and the like includes the number recited. As used herein, the meaning of “a,” “an,” and “said” includes plural reference unless the context clearly dictates otherwise. Also, as used in the description herein, the meaning of “in” includes “into” and “on,” unless the context clearly dictates otherwise.

While the structures and/or methods are discussed herein in terms of elements labeled by ordinal adjectives (e.g., first, second, etc.), the ordinal adjectives are used merely as labels to distinguish one element from another, and the ordinal adjectives are not used to denote an order of these elements or of their use.

Various configurations have been described above. It is to be appreciated that the implementations disclosed herein are not mutually exclusive and may be combined with one another in various arrangements. Although this invention has been described with reference to these specific configurations, the descriptions are intended to be illustrative of the invention and are not intended to be limiting. Various modifications and applications may occur to those skilled in the art without departing from the true spirit and scope of the invention. Thus, for example, in any method or process disclosed herein, the acts or operations making up the method/process may be performed in any suitable sequence and are not necessarily limited to any particular disclosed sequence. Features or elements from various implementations and examples discussed above may be combined with one another to produce alternative configurations compatible with implementations disclosed herein. In addition, although the disclosed methods and apparatuses have largely been described in the context of various devices, various implementations described herein can be incorporated in a variety of other suitable devices, methods, and contexts.

Various aspects and advantages of the implementations have been described where appropriate. It is to be understood that not necessarily all such aspects or advantages may be achieved in accordance with any particular implementation. Thus, for example, it should be recognized that the various implementations may be carried out in a manner that achieves or optimizes one advantage or group of advantages as taught herein without necessarily achieving other aspects or advantages as may be taught or suggested herein.

1. A system comprising:
a stage configured to support a sample comprising at least first and second atomic elements, the first atomic element having a first characteristic x-ray line with a first energy, the second atomic element having a second characteristic x-ray line with a second energy, the second energy greater than the first energy, the first energy and the second energy lower than 8 keV and separated from one another by less than 1 keV;
an x-ray source comprising at least one target material configured to produce x-rays having a third energy between the first and second energies; and
at least one x-ray optic configured to receive and focus at least some of the x-rays from the x-ray source as an x-ray beam to illuminate the sample, at least 70% of the x-ray beam having x-ray energies that are below the second energy.

2. The system of claim 1, wherein the x-ray beam has a spot size at the sample in a range of 1 micron to 25 microns.

3. The system of claim 1, wherein the at least one x-ray optic has a cut-off energy that is in a range 50% to 100% of an absorption edge energy associated with the second characteristic x-ray line.

4. The system of claim 1, wherein the first and second energies are separated from one another by less than 500 eV.

5. The system of claim 1, wherein the first and second atomic elements are silver and tin, and the sample comprises solder.

6. The system of claim 1, wherein the at least one target material is an electrically insulating material.

7. The system of claim 6, wherein the electrically insulating material comprises a ceramic material.

8. The system of claim 1, wherein the at least one target material comprises at least one third atomic element having at least one third characteristic x-ray line with the third energy.

9. The system of claim 1, further comprising a spectral filter configured to be impinged by the x-rays produced by the at least one target material, the spectral filter comprising the second atomic element.

10. The system of claim 9, wherein the spectral filter comprises a compound of Ca.

11. The system of claim 9, wherein the spectral filter is positioned between the at least one target material and the at least one x-ray optic.

12. The system of claim 1, wherein the x-ray beam has a spot size at the sample in a range of 3 microns to 20 microns.

13. The system of claim 1, wherein the x-ray optic is configured to demagnify the x-ray beam by a ratio in a range of 2:1 to 10:1.

14. The system of claim 1, wherein the target material comprises an electrically insulating target material having a thickness less than 10 microns, the target material configured to emit x-rays upon being impinged by electrons accelerated by an accelerating voltage in a range of 5 kVp to 30 kVp, the x-ray source further comprising a diamond substrate material in thermal communication with the target material, the diamond substrate material configured to transfer heat away from the target material, the heat generated by the target material being impinged by the electrons.

15. The system of claim 14, wherein the x-ray source further comprises an intermediate layer between the target material and the diamond substrate material, the intermediate layer comprising a material different from the target material and the diamond substrate material.

16. The system of claim 15, wherein the intermediate layer has a thickness less than 100 nanometers.

17. The system of claim 14, wherein the target material comprises at least one Ca-containing material.

18. The system of claim 14, wherein the target material comprises a ceramic material.

19. The system of claim 14, further comprising a coating over the target material.
